(19) United States
(12) Patent Application Publication
(10) Pub. No.: US 2003/0210453 A1
(43) Pub. Date: Nov. 13, 2003

(54) Optical device and a movable mirror driving method

(75) Inventor: Shunji Noda, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/419,947

(22) Filed: Apr. 22, 2003

(30) Foreign Application Priority Data
May 9, 2002 (JP) 133924/2002

(51) Int. Cl. G02B 26/00

(52) U.S. Cl. 359/290

(57) ABSTRACT

An optical device characterized by comprising; a movable mirror between a first substrate and a second substrate, a first pair of a movable mil-or driving devices on the first substrate and a second pair of a movable mirror driving devices on the second substrate. The first pair of the movable mirror driving device are made of an optical signal-transmissible material. The first pair of a movable mirror driving devices and the second pair of a movable mirror driving devices arranged on the surface side and the rear surface side of the movable mirror. The mirror is inclined by the electrostatic attractive force between the movable driving devices and the mirror to control the reflection direction of the optical signal.

### BACKGROUND OF THE INVENTION

1. Field of the Invention

The present invention relates to an optical device, and more particularly an optical device for use in an optical communication system or the like, and for reflecting spatially an optical signal using a movable mirror. And the present invention relates to a method for driving the movable mirror.

2. Description of the Related Art

Optical communication in which an optical fiber is used as a transmission line has increased according to the increase in communication traffic. Along with the increase in the use of optical communication, the value of a node system such as an OXC (Optical Cross Connect) of a basic system, and an OADM (Optical Ado Drop Module) in a mesh type network has been increased. Optical devices have become key devices in such a node system.

Among those, in particular, an optical switch has been in the spotlight as a core of the node technology. Because it can switch an optical signal at high speed in its entirety without converting the optical signal into an electrical signal, it has the merit that the system cost can be greatly reduced.

Conventionally, an optical device is disclosed in U.S. Pat. No. 6,300,619B1. FIG. 1 shows an optical device described in this patent. A mirror 17 formed by depositing polysilicon and a frame 91 are coupled to each other through springs 32. And the frame 91 and mirror fixing

portions 20a and 20b are coupled to each other through springs 30. And the mirror fixing portions 20a and 20b are coupled to a silicon substrate 13 through beams 19a and 19b, and beams 26a and 26b, respectively. Then, the beams 19a, 19b and 26a, 26b are bent by thermal deformation so that the mirror structure including the mirror 17, the frame 91, the springs 30 and 32, and the mirror fixing portions 20a and 20b rises in the Z-axis direction (i.e., the direction perpendicular to the paper) from the silicon substrate 13.

Electrode pads (not shown) are previously formed on the silicon substrate 13 located below the mirror 17 and the mirror 17 is rotated and driven by the electrostatic force which is generated by applying a voltage across the mirror 17 and the electrode pads. Then, the mirror 17 is driven around the two axes (the X-axis and the Y-axis) of the springs 30 and 32 to reflect an optical signal applied to the mirror 17 in an arbitrary direction, thereby carrying out spatially the optical path switching.

As for the prior art showing the basic structure of the movable mirror, there is one disclosed in U.S. Pat. No. 6,275,326B1. FIG. 2 shows the construction of an optical device described in that U.S. patent. A pair of electrodes 17 are arranged on a substrate 13 and a movable mirror 15 is disposed above the substrate 13 with a suitable gap provided therebetween. The movable mirror 15 is supported by springs 18, 19. Strain gages 21 may be connected to springs 18,19. Now, a voltage is applied across the electrodes 17 to generate the electrostatic force between the electrodes 17 and the movable mirror 15, thereby being able to rotate and drive the movable mirror 15 around the axis of the springs 18, 19. However, such conventional movable mirrors have various problems. First of all, there is encountered the problem that a large voltage is required to drive the mirror. The electrostatic force as the driving source for the mirror is in proportion to an area of a capacitor, but is in inverse proportion to the gap squared. However, in the device using the movable mirror of this sort, in general, a micromirror is used, and its diameter is equal to or smaller than 1 mm. For this reason, the effective electrode area is necessarily limited to a small area. In addition, while the area in which the reflected light can be propagated is further spread as the driving angle of the mirror is larger, the large rotation of the mirror causes the mirror to come in contact with the substrate on the electrode side. For this reason, it is inevitable that the gap is made large to some degree. Due to such a condition, the efficiency of the electrostatic force type actuator becomes poor, and hence a large voltage is required for driving of the mirror.

The second problem is such that there is the sinking of a mirror. While the mirror, as described above, is drawn by the electrostatic force acting between the electrodes, if this electrostatic force operates perfectly on the spring in the form of a moment, then the mirror is accurately rotated and driven around the axis of the springs. However, since the component for dropping the mirror vertically to the electrode side operates naturally on the mirror, the spring is not twisted in the rotational direction, but is bent in the direction of the sinking of the mirror. When the voltage is going to be increased to some degree, there is the possibility that the whole mirror may be dropped onto the electrode substrate. There occurs a case where, in the extreme case, the mirror and the electrode substrate adsorb each other, which makes it impossible for the mirror to return. As a result, the mirror may lose the function as the movable mirror.

The third problem is the difficulty of manufacturing the spring. The spring is need to extremely weaken the rotational rigidity of the spring for supporting the mirror. It is to solve the above-mentioned two problems. That is to say, weakening the rotational rigidity of the spring aims at suppressing the promotion of the large voltage and the reduction of driving voltage can assist to reduce the sinking of the spring. However, it is very difficult to manufacture an extremely narrow spring with a width in the range of 1 to 2 μm.

As a related art for improving the above-described three problems, there may be cited “Single Crystalline Mirror Actuated Electrostatically by Terraced Electrodes With High-Aspect Ratio Torsion Spring” by Renshi Sawada @NTT Telecommunications Energy Laboratories presented at International Conference of Optical MEMS 2001.

In the optical switch, similarly to the optical switch described above, electrodes and a mirror are arranged apart from each other with a certain clearance, and the mirror is rotated and driven by the electrostatic force. FIG. 3 shows the construction of this optical switch. In this alt, a mirror is formed in a device layer of an SOI (Silicon On Insulator) substrate. When forming a mirror, a device layer 101 is patterned for formation of a mirror 102 and springs 103, and a backing member 106 is etched to form the mirror structure. On the other hand, on the electrode side, stepped portions 107 are formed, and electrodes 108 are respectively arranged along the stepped portions 107. In addition, ditches 109 are formed in the electrode substrate so as to be in continuity with the respective stepped portions. Next, this mirror structure is joined to the electrode substrate 104 through a support post 105 to complete the optical device.

In this construction, since the electrodes are respectively arranged along the stepped portions, the area of a capacitor for generation of the electrostatic force can be effectively obtained. In addition, the formation of the ditches along the stepped portions makes it possible to prevent the mirror from coming in contact with the electrode substrate when the mirror is rotated. This results in that the gap of the capacitor can be reduced and that a large quantity of rotation of the mirror can be attained. Further, a pivot 110 is provided on the top of the stepped portions to prevent the sinking of the mirror.

However, in this case as well, there are encountered problems. First of all, for the formation of the stepped portions in the electrodes, there is need for carrying out repeatedly the mask patterning process and the etching process plural times. In addition, the processes having the high degree of difficulty such as the exposure technique for the long depth and the process for applying photoresist to complicated uneven surface are further required for the patterning as the depth of the stepped portions is deeper. Consequently, the productivity becomes poor.

Furthermore, when the sinking of the mirror is intended to be prevented by the provision of the pivot, the abrasion of the pivot can not be avoided since the mirror and the pivot come in contact with each other in order to prevent the sinking of the mirror. Moreover, there is the possibility that the dust which is generated during the abrasion may cause the short-circuit of the wiring, the operational trouble of the mirror, and the like.

As for a method for solving these problems, while being different in application from an optical switch, there is a galvano-micromirror of a double-sided electrode type disclosed in JP 2001-290099 A and JP 2001-13443 A. FIG. 4 shows a galvano-micromirror described on these published applications. There is adopted the construction that electrode pads 32a and 32b are arranged below a mirror 31, electrode pads 33a and 33b are arranged above the mirror 31, and the mirror is driven using the electrostatic forces generated in both of the upper-side electrodes and the lower-side electrodes. In such a manner, the mirror 31 is pulled to both of the upper-side and lower-side electrodes and increase the driving force in the vertical direction. And then each of the vertical forces are canceled, it is possible to solve the problem with respect to the sinking and the drop of the mirror.

However, in the mirror of this sort, since the electrodes 33a and 33b provided above the mirror cut off the optical signal incident path to the mirror, the electrodes need to be arranged on the outside sufficiently apart from the area defining the reflection surface of the mirror 31. For this reason, tab-like projections 34a and 34b need to be provided in the mirror 31 in the positions facing the electrodes. This increases the rotational radius of the mirror and reduces the movable range thereof. As described above, in such an optical device, it is important to obtain the wide movable range of the mirror. However the projections projecting outwardly from the mirror become a serious demerit.

In addition, the galvano-mirror described in the above-mentioned published application may be available in using one mirror as the optical device, but in the case where several hundreds to several thousands of mirrors need to be arranged in a matrix as in the optical switch, it is difficult to design the wiring to be distributed so as to avoid the optical signal incident path to the mirror.

As described above, in the conventional optical devices, the driving which is adapted to the low voltage and which is free from the sinking of a mirror is difficult to be attained, which results in that the construction becomes complicated, thereby increasing the degree of difficulty of the manufacturing process. In addition, in the case where the double-sided electrodes are used for the purpose of preventing the promotion of the low voltage and the sinking of a mirror, there are encountered the problems such as the reduction of the movable range of a mirror and the obstruction of the large scale integration of an optical device.

### BRIEF SUMMARY OF THE INVENTION

The present invention has been made in view of the above-mentioned problems. It is therefore an object of the present invention to provide a optical device which can increase the mirror movable range and allow large scale integration.

According to a first aspect of the present invention, an optical device is characterized by a movable mirror between a first substrate and a second substrate, a first pair of a movable mirror driving devices on the first substrate and a second pair of movable mirror driving devices on the second substrate, wherein the first pair of a movable mirror is made of an optical signal-transmissible material.

Here we call the movable mirror driving device of the side where an incident optical signal moves to the movable mirror “a first pair of a movable mirror driving devices. In another way, we may call the side where an incident optical signal moves to the movable mirror to “upper-side”. So “a first substrate” is the side an incident optical signal moves to.

Then, we call the movable mirror driving device in the opposite side of the side where an incident optical signal moves to the movable mirror “a second pair of a movable mirror”. And we call this side “lower-side”. So, “a second substrate” is the opposite side to the first side through the mirror.

According to the present invention, the driving forces are generated from a upper-side and a lower-side of a mirror. And the first pair of a movable mirror driving device is made of an optical signal-transmissible material, which makes it possible to prevent an optical signal made incident on a mirror reflection surface from being broken by a driving device. And then, it makes it possible to arrange the driving device right above the mirror reflection surface as an incident path of the optical signal. Thus, there is no need to provide any extra-projection portions projecting outwardly from the mirror as in the prior art, which makes it possible to reduce the rotational radius of a mirror, and as a result, to increase the driving range of the mirror.

Moreover, the rotational radius of the mirror is small, it is possible to narrow the distance between the mirror and the driving device which is arranged on either, upper-side or lower-side of the mirror, which makes it possible to decrease the driving voltage.

In addition, since at least the first pair of the driving device is made of an optical signal-transmissible material, the restriction to electrode wiring on side in which the optical signal is made incident on the mirror is eliminated, which results in the promotion of large scale integration of an optical device become easy.

A second aspect of the present invention is a method of driving a movable mirror characterized by driving the mirror by the electrostatic force generated between a electrode as a movable mirror driving device composed of a optical signal-transmissible material and said movable mirror.

According to the method, it can be obtained the effect above mentioned since the electrode can prevent an optical signal made incident on a mirror reflection surface from being broken. And it makes it possible to drive the mirror easily and control the inclination angle of the mirror by adjusting the applied voltage.

### BRIEF DESCRIPTION OF THE DRAWINGS

FIG. 1 is a view showing a conventional optical device.

FIG. 2 is a view showing another conventional optical device.

FIG. 3 is a view showing another conventional optical device.

FIG. 4 is a view showing another conventional optical device.

FIG. 5 is a perspective view showing an optical device according to an embodiment of the present invention.

FIG. 6 is a view showing the operation of a mirror of the optical device according to an embodiment of the present invention.

FIG. 7 is an exploded perspective view showing the optical device of the embodiment of the present invention.

FIG. 8 is an across sectional view showing the operation of the present embodiment.

FIG. 9(a) to (d) are showing cross sectional views useful in explaining the effects of the present embodiment.

FIG. 10 is a view useful in explaining the sinking of a mirror.

FIG. 11 is a view useful in explaining the effects of the present invention.

FIG. 12 is a graph showing the relationship between an inclination angle θ and a force F applied to a mirror in FIG. 11.

FIG. 13 is a plan view showing an optical device according to another embodiment of the present invention.

FIG. 14 a view showing an application example of the embodiment of the present invention.

FIG. 15 is a cross sectional view showing still another embodiment of the present invention.

### DETAILED DESCRIPTION OF THE INVENTION

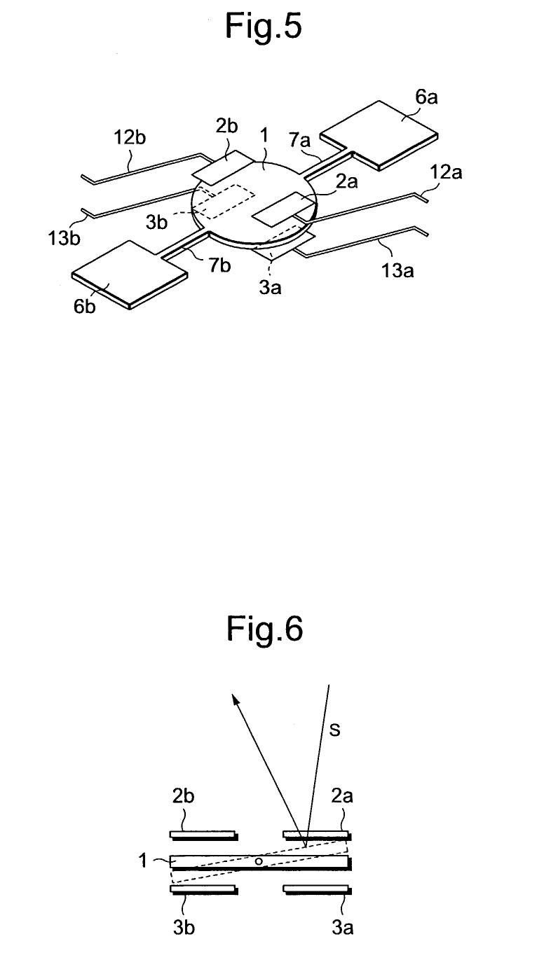

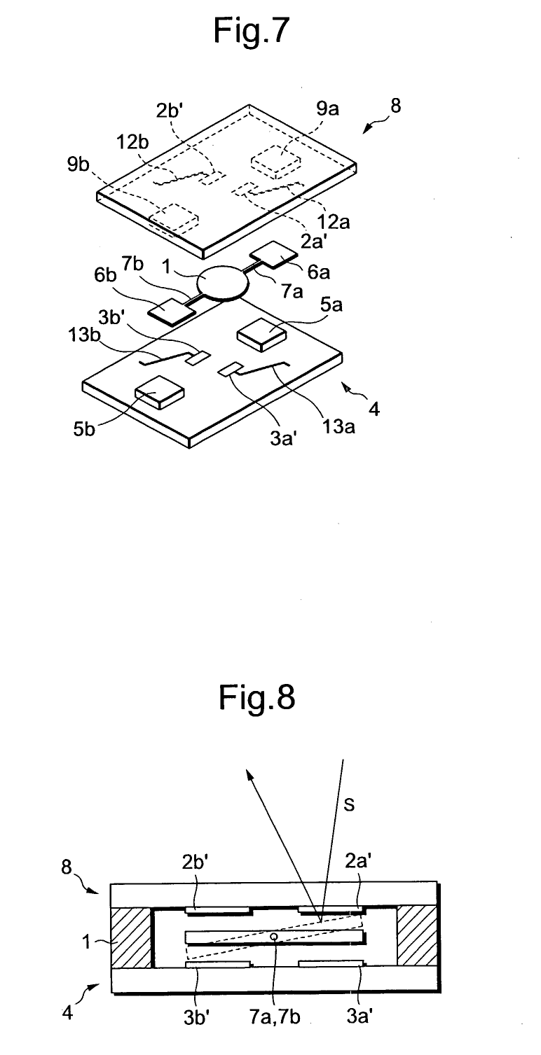

FIG. 5 is a perspective view showing an optical device according to a first embodiment of the present invention, FIG. 6 is a front view showing the operation of a mirror 1. FIG. 7 is an exploded perspective view thereof, and FIG. 8 is a cross sectional view showing the operation of the optical device of the present embodiment.

The optical device of the present invention includes movable mirror 1, a first pair of a movable mirror driving devices 2a, 2b, and a second pair of a movable mirror driving devices 3a, 3b. The first pair of the movable mirror driving devices 2a, 2b are arranged above the periphery of a mirror 1 in such a manner as to be parallel to the mirror 1 and suitably spaced apart from the mirror 1. Here “above of the mirror” is the side where an incident optical signal S moves to the movable mirror (FIG. 2). We call the side “the first side” or “the upper-side”.

The second pair of the movable mirror driving devices 3a, 3b are arranged below the periphery of the mirror 1 in such a manner as to be in parallel to the mirror 1 and suitably spaced apart from the mirror 1. Here “below of the mirror” is the opposite side of the upper-side, so we may call the side “the second side” or “the lower-side”. The first pair of the movable mirror driving devices 2a and 2b are arranged in such a manner as to oppose the second pair of the movable mirror with the mirror 1 sandwiched therebetween.

The mirror 1 is supported by anchors 6a and 6b through springs 7a and 7b. The anchors 6a and 6b are at the end portion of perpendicular direction in which the driving devices 2a and 2b face each other. In addition, the driving devices 2a, 2b, and 3a, 3b are adapted to be electrically drawn to the outside with wirings 12a, 12b and 13a, 13b, respectively.

Next, a method of manufacturing this optical device, the concrete construction, and the operation of the optical device thereof will hereinbelow be described.

In FIG. 7, the second (lower-side) substrate 4 is the electrode substrate. It may be a silicon substrate on the surface of which an insulating film such as an oxide film is formed. Then, the silicon substrate is subjected to the deep dry etching to form support posts' 5a and 5b in the lower-side electrode substrate 4. The height of the support posts 5a and 5b corresponds to the gap of a capacitor defined using the lower-side electrode. Note that, as for the method of forming these Support posts 5a and 5b, in addition-thereto, the support posts 5a and 5b may also be formed by sticking polyimide resin to a material other than silicon, such as a glass substrate.

Next, the driving device and wirings 13a and 13b are formed on the electrode substrate 4 with the posts. The driving device are the electrode pads 3a′ and 3b′. Then, the electrodes pads 3a′ and 3b′ can be formed by depositing an electrically conductive material such as aluminium or polysilicon onto the electrode substrate 4 to pattern the electrically conductive material thus deposited.

The support posts 5a and 5b of the lower-side electrode substrate 4 are loaded with the mirror 1. The mirror 1 is manufactured using silicon, likewise the electrode substrate. At this time, the mirror 1, the springs 7a.and 7b, and the anchors 6a and 6b are formed integrally with one another using silicon. However, these constituent elements may also be formed in such a way that after the individual members are separately formed, they are joined to one another. For example, the mirror 1 may be made of silicon, and also the springs 7a and 7b, and the anchors 6a and 6b may be made of a metal material such as aluminum.

Then, the anchors 6a and 6b are respectively put on the support posts 5a and 5b to join them to each other. Thus, the mirror 1 is supported by the support posts 5a and 5b in the state in which it is suspended through the springs 7a and 7b. In this case, the electrode pads 3a′ and 3b′ are arranged below the edge portion of the rear surface of the mirror 1 and in parallel to the mirror 1 so that the electrostatic force is applied between the electrode pads 3a′ and 3b′, and the rear surface of the mirror 1.

Thereafter, the first (upper-side) electrode substrate 8 which is formed in a similar manner is arranged above the mirror 1. It may be made of a transparent material adapted to transmit an optical signal since the upper-side electrode substrate 8 is arranged on the side in which an optical signal is made incident with respect to the mirror 1. For example, the upper-side electrode substrate 8 is a transparent glass substrate. Then, after polyimide resin has been stuck onto the lower surface of the upper-side electrode substrate 8, polyimide resin is etched to form the support posts 9a and 9b. The height of these support posts 9a and 9b corresponds to the gap of a capacitor defined using the upper-side electrode.

Next, the driving device and the wirings 12a and 12b are formed on the lower surface of the upper-side electrode substrate 8 on which the support posts are formed. The driving devices are electrode pads 2a′ and 2b′. The electrode pads 2a′ and 2b′ are optical signal-transmissible material since the electrode pads 2a′ and 2b′ is arranged on the side in which an optical signal is made incident with respect to the mirror 1. The electrode pads 2a′ and 2b′ and the wirings 12a and 12b can be formed by depositing an optical signal-transmissible material, such as polysilicon, having the electrical conductivity to pattern the optical signal-transmissible material thus deposited. The second substrate and the lower-side electrode may also be optical signal-transmissible material.

In addition, each of the electrode pads 2a′ and 2b′ may be arranged on an optical signal incident path to the movable mirror. Then, a capacitor is defined between the electrodes and the movable mirror to drive the mirror. And the electrostatic force is generated between the electrode pads 2a′, 2b′, 3a′, and 3b′ respectively and the mirror. The mirror can be controlled by the electrostatic force between at least one electrode pad and the mirror. But it is preferred to use the electrostatic force between two electrodes diagonally to each other, e.g. 2a′, 3b′ and the mirror, according to the reason described thereafter.

In addition, for example, each of the one pair of mirror driving devices may be coils formed on the substrate. The electromagnetic force generated between the coil and mirror drives the mirror. In this case, a part of or all of the movable mirror are deposited magnetic material. Thus, the electromagnetic force is caused between the coil and the mirror. Of course, in this case, at least the coils on the upper-side are made of an optical signal-transmissible material.

Next, the mirror 1 is loaded with the upper-side electrode substrate 8. At this time, the support posts 9a and 9b are respectively put on the anchors 6a and 6b to join them to each other, thereby assembling the upper-side electrode substrate 8, the mirror 1, and the lower-side electrode substrate 4. As a result, the anchors 6a and 6b are held and fixed between the Support posts 5a and 5b and the support posts 9a and 9b, and the mirror 1 is held in the state in which it floats in the air through the springs 7a and 7b. Note that, the electrode pads 3a′ and 3b′ of the upper-side electrode substrate 8 are arranged above the edge potion of the mirror 1 and in parallel to the mirror 1 so that the electrostatic force is applied between the electrode pads 3a′ and 3b′ and the mirror 1.

Next, the description will hereinbelow be given with respect to the operation of the optical device of the present embodiment constructed in a manner as described above. As shown in FIG. 8, first of all, a voltage is applied across the electrode pad 2a′ and the electrode pad 3b′ which is located diagonally with respect to the electrode pad 2a′ to generate the electrostatic force between these electrode pads and the mirror 1. Then, the electrode pads 2a′ and 3b′ and the mirror 1 attract each other by the electrostatic force so that the mirror 1 is swung counterclockwise as shown in the figure. Then, the torsion is generated in the springs 7a and 7b. In this case, adjusting the applied voltage makes it possible to control the inclination angle of the mirror 1 to a predetermined angle on the basis of the balance between the electrostatic attractive force and the reaction force of the springs 7a and 7b. As a result, optical signal S which is transmitted through the upper-side electrode substrate 8 to be made incident can be reflected in a predetermined direction. Then, control of the applied voltage makes it possible to control the inclination angle of the mirror 1, which allows the reflection direction of the optical signal S be controlled to an arbitrary direction.

In the present embodiment, since each of the upper-side electrode substrate 8 (including the support posts 9a and 9b), the electrode pads 2a′ and 2b′, and the wirings 12a and 12b is made of a transparent material, the optical signal S is transmitted through the upper-side electrode substrate 8 to be made incident on the mirror 1. Thus, the mirror 1 does not need to be provided with any of the projection portions as in the prior art and hence it is possible to avoid enlargement in the size of the mirror. Thus, the rotational radius of the mirror 1 is small and the movable range is wide. In addition, the signal wiring is readily distributed, which results in that the large scale integration of the optical device becomes possible.

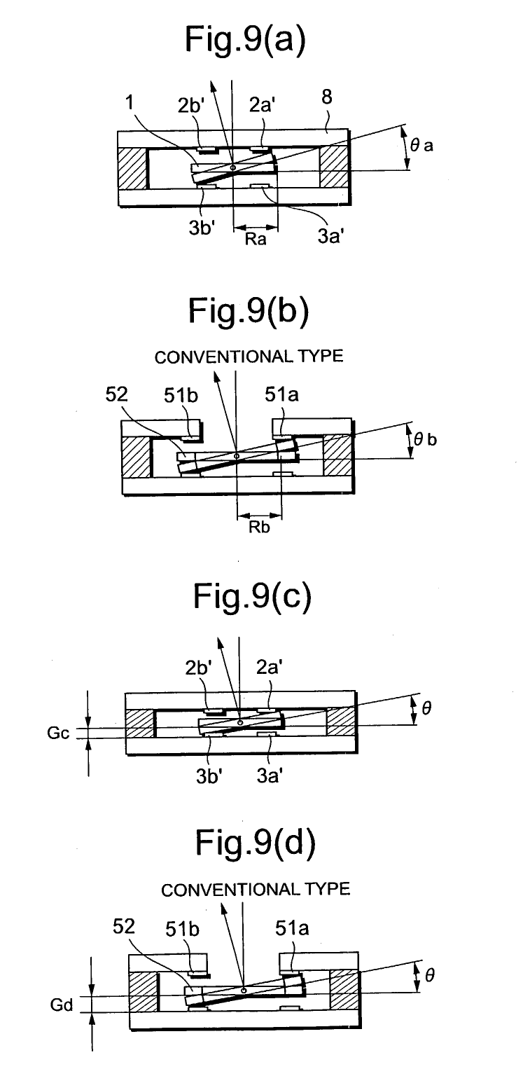

FIGS. 9(a) to 9(d) are respectively cross sectional views showing the movable range of the mirror on the comparison with the conventional optical device. As shown in FIG. 9(a), in the case of the optical device according to the present embodiment, since each of the electrode pads 2a′ and 2b′ and the substrate 8 is made of a transparent material, and hence transmits an optical signal, the mirror 1 itself has a disc-like shape and hence can reflect the optical signal over the whole area thereof. Thus, there is no need for providing any of extra-projection portions. For this reason, the rotational radius Ra in the periphery of the mirror 1 is small and the maximum inclination angle θa at which the mirror 1 can be swung is large. On the other hand, as shown in of FIG. 9(b), in the case of the conventional optical device, since each of electrode pads 51a and 51b is non-optical signal-transmissible, it is necessary to provide an opening portion through which an optical signal is made incident on the mirror in a part of the substrate above the mirror, and it is also necessary to provide, in addition to a disc-like reflection surface, projection portions 52 adapted to face the electrode pads 51a and 51b. For this reason, a rotational radius Rb of the mirror is large and hence the maximum inclination angle θb at which the mirror makes as much swing as possible is small. Thus, in the case of the present embodiment, the movable range of the mirror is wider than that of the conventional optical device.

In addition, in the case where it is assumed that the movable range of the mirror of the present embodiment is identical to that of the conventional optical device (inclination angle 0), in the optical device of the present embodiment shown in FIG. 9(c), a gap Gc defined between the mirror and the lower-side electrode substrate is small. On the other hand, in the case of the conventional optical device shown in FIG. 9(d), since the projection portions 52 are present, a gap Gd defined between the mirror and the lower-side electrode is large. That is to say, the relationship of Gc<Gd is established, and hence in the case of the present embodiment, it is possible to miniaturize the optical device. For this reason, in the present embodiment, the voltage required to drive the mirror can also be reduced.

In addition, the optical device in the present invention may be obtained the effect with only the one-side electrode pads. However, it is preferred to the electrode pads with both upper-side and lower-side.

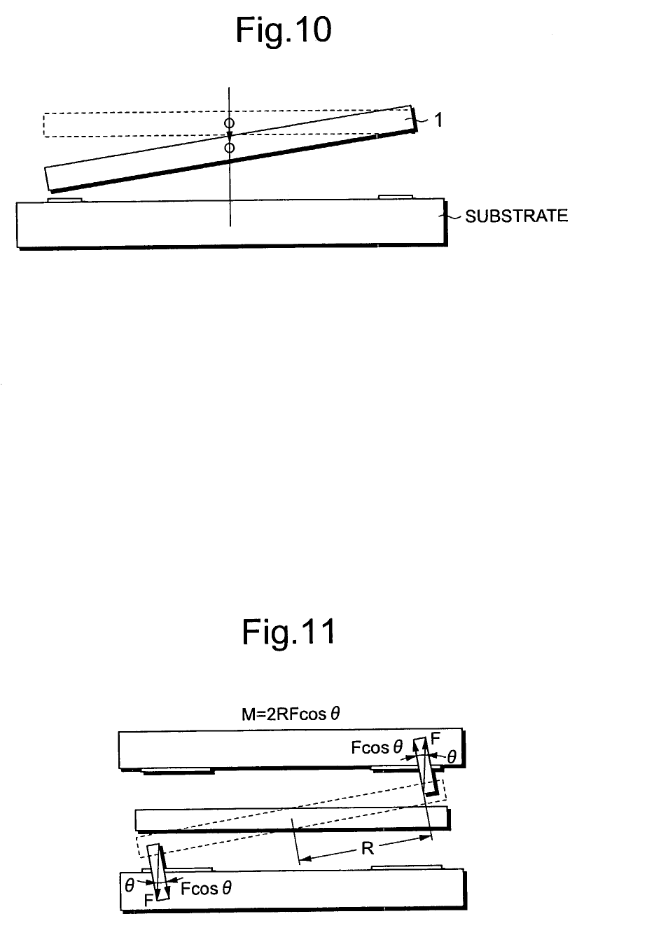

If the required inclination angle of the mirror is to be similarly obtained with only the one-side electrode pads, it is necessary to apply the twofold voltage to the electrode pads. Also, as shown in FIG. 10, the whole mirror 1 is sunk to the electrode pad side (substrate side) so that the axial center of each of the springs is moved toward the substrate side to change the swing center of the mirror 1. This results in that the mirror 1 is not swung at a desired inclination angle. If such a behavior occurs, not only the positional control for the mirror becomes difficult, but also when a large voltage is going to be applied, the error mode in which the whole mirror is dropped onto the electrode is generated.

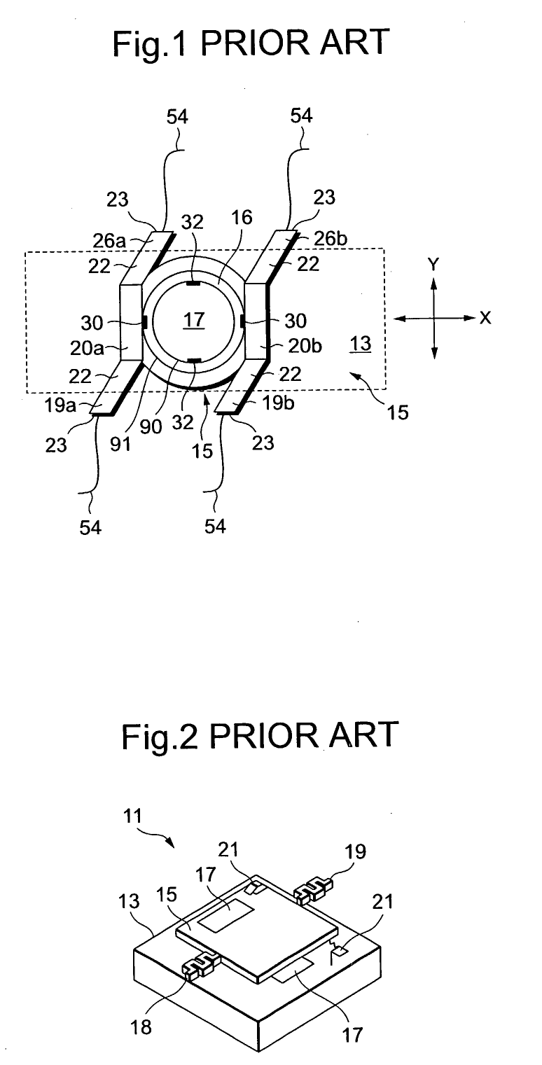

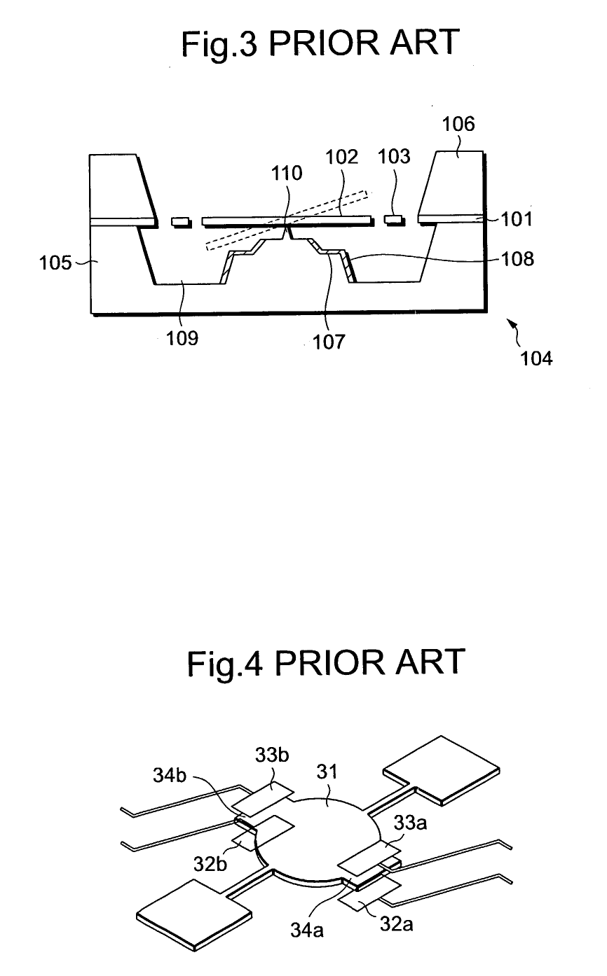

On the other hand, in the embodiment of the present invention, as shown in FIG. 1, since the electrostatic forces are simultaneously generated from the upper electrode substrate and the lower electrode substrate which are located on the upper side and the lower side of the mirror, the vertical force components F are cancelled, and the angular moment component 2RF cos θ (R: working radius, θ: mirror rotational angle) works perfectly. As a result, the mirror 1 is rotated around the axis of the springs to prevent generation of the error such that the mirror 1 is dropped onto the substrate on which the electrode pads are provided.

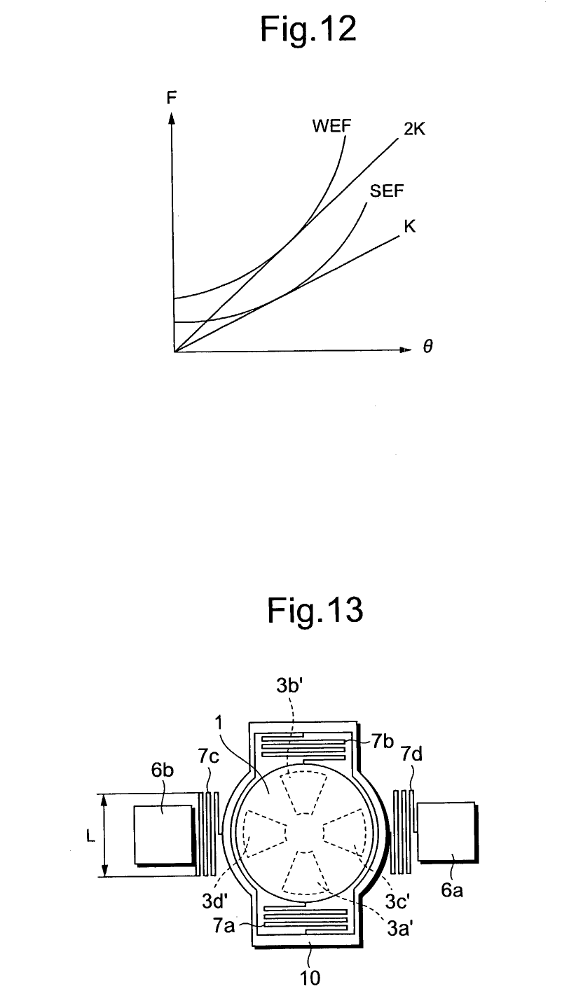

In addition, in the embodiment of the present invention, unlike the one-side electrode structure, the twofold electrostatic attractive force can be generated even with the same voltage. The relationship between the mirror rotational angle and the generated force representing this fact is shown in FIG. 12. FIG. 12 is a graph showing the relationship between them in which the axis of abscissa represents the mirror rotational angle θ, and the axis of ordinate represents the generated force F. SEF represents the electrostatic force which is generated only in the one-side electrode, while WEF represents the electrostatic force which is generated in both of the upper-side electrode and the lower-side electrode. The curves in the figure represent the electrostatic forces which are generated with the electrodes, and form roughly quadratic curves which are increased since the gap of the capacitor becomes smaller as the rotational angle of the mirror is further increased. On the other hand, the straight lines in the figure show the reaction forces caused by a spring. The reaction forces caused by the spring become large in proportion to a quantity of torsion as the mirror is rotated to generate the torsion. The proportion coefficient at this time becomes the spring coefficiency corresponding to the rigidity of the spring.

As apparent from FIG. 12, the electrostatic force WEF which is generated in both of the upper-side electrode and the lower-side electrode is roughly two times as large as the electrostatic force SEF which is generated only in one-side electrode. Note that, in the electrostatic driving structure of this sort, it becomes essential that for the relationship between the reaction force caused by the spring and the electrostatic force, (electrostatic force)>(reaction force caused by spring) is established. If the mirror rotational angle in which the reaction force caused by the spring is larger than the electrostatic force is present, then the reaction force can not be controlled by the electrostatic force to fix the mirror. In the figure, Kθ and 2Kθ expressed by the straight lines are respectively the reaction forces caused by the spring having the maximum rigidities which can be allowed in terms of the spring against the respective electrostatic forces. In such a way, the electrostatic force can be doubled, which makes it possible to double the rigidity of the spring. In addition, although not illustrated in FIG. 12, since in the present embodiment, as described with reference to FIGS. 9(c) and 9(d), the promotion of the lower voltage is attained as compared with the conventional mirror having the double-sided electrodes, similarly, the spring rigidity can be increased.

The fact that the spring rigidity can be increased provides the remarkable merit in terms of the manufacturing process. While in the present embodiment, the thickness of the springs is set to 3 μm and width thereof is set to 7 μm, it is required for the conventional one-side electrode that the thickness of the spring is equal to or smaller than 2 μm or equal to or smaller than 1 μm if stable control is expected. Thus, there occurs the necessity for manufacturing the spring having extremely low rigidity as described above, and hence there is encountered the serious problems such as a reduction in yield in the manufacturing process, and a reduction in reliability of the products.

As described above, in the present invention, the movable range of the mill-or can be increased, the driving voltage for the mirror can be decreased, the sinking and the drop of the mirror can be prevented, and also the allowable value for the spring rigidity can be enhanced, which results in that it is possible to realize the stabilization of the manufacturing process and the high reliability of the products.

Next, the second embodiment of the present invention is described here below.

In the above-mentioned embodiment, the mirror 1 is a single-axis rotation mirror supported by one pair of springs 7a and 7b. However, with this construction, the range of the reflected light which can be scanned is compelled to fall on one straight line. However, as shown in FIG. 13, the mirror 1 is constructed in the form of a two-axes rotation mirror supported by two pairs of springs 7a and 7b, 7c and 7d. It is able to control more accurately the reflection angle of signal light by the springs.

The mirror 1, for example, is 50 μm in diameter and is 20 μm in thickness. A frame 10 is arranged in such a manner as to surround the mirror 1. Anchors 6a and 6b and the frame 10 are linked through one pair of springs 7c and 7d so that the frame 10 is supported by the anchors 6a and 6b. The end portions of the mirror 1 in the direction perpendicular to the direction along which the anchors 6a and 6b face each other and the frame 10 are similarly linked with each other through the springs 7a and 7b so that the mirror 1 is supported by the frame 10. In addition, lower electrode pads 3a′ to 3d′ are arranged in the four-equally-divided positions in the circular direction of the mirror 1. One pair of lower electrode pads 3a′ and 3b′ are arranged so as to face the direction perpendicular to the direction along which the anchors 6a and 6b face each other, and one pair of lower electrode pads 3c′ and 3d′ are arranged so as to face the direction along which the anchors 6a and 6b face each other. Note that, upper electrode pads (not shown) of the upper electrode substrate, likewise the above-mentioned lower electrode pads of the lower electrode substrate, are also arranged in the four-equally-divided positions in the circular direction of the mirror 1.

In the optical device constructed in such a manner, for example, a voltage is applied across the electrode pad 3b′ and the electrode pad of the upper electrode substrate which is arranged diagonally with respect to the electrode pad 3b′ it is to swing the mirror 1 in the direction in which it approaches the electrode pad 3b′ by the electrostatic attractive force. As a result, the mirror 1 is inclined completely in the similar manner as in FIG. 8. The frame 10 is also similarly inclined. On the other hand, when a voltage is applied across the electrode pad 3c′ and the electrode pad of the upper electrode substrate which is arranged diagonally with respect to the electrode pad 3c′, the frame 10 is not inclined. But only the mirror 1 is inclined in the direction along which the anchors 6a and 6b face each other by the electrostatic force. Furthermore, when voltages are applied across the adjacent electrode pads, e.g., both of the electrode pads 3b′ and 3c′ and both of the electrode pads of the upper electrode substrate which are respectively arranged diagonally with respect to those electrode pads 3b′ and 3c′, both of the mirror 1 and the frame 10 are inclined. And also the mirror 1 is inclined with the direction of an acute angle with respect to the direction along which the anchors 6a and 6b face each other as the swing axis. The acute angle depends on the magnitudes of the voltages applied to the electrode pad 3b′ and the electrode pad 3c′, and when the magnitudes of these voltages are identical to each other, basically, the mirror 1 is inclined with the direction of inclination of 45 degrees with respect to the direction along which the anchors 6a and 6b face each other as the swing axis.

In FIG. 5, each of the springs 7a to 7b shows a simple straight bead-like shape. In this embodiment, in FIG. 13, it has a zigzagged-crimp shape. Thus, each of the springs 7a to 7d has the crimps so that it is easily twisted. A concrete shape of each of the springs 7a and 7d shown in FIG. 13, for example, is 300 μm in length, 3 turns in number of crimps of the spring, 3 μm in thickness, and 7 μm in width. In addition, the height of each of the support posts 5a, 5b and 9a, 9b defining the gap of the capacitor, for example, is 100 μm. Moreover, with respect to the applied voltage, for example, 50V is applied across the electrode pads of the upper electrode substrate and the electrode pads of the lower electrode substrate simultaneously. As a result, for example, the inclination of the mirror 1 can be held at 10 degrees.

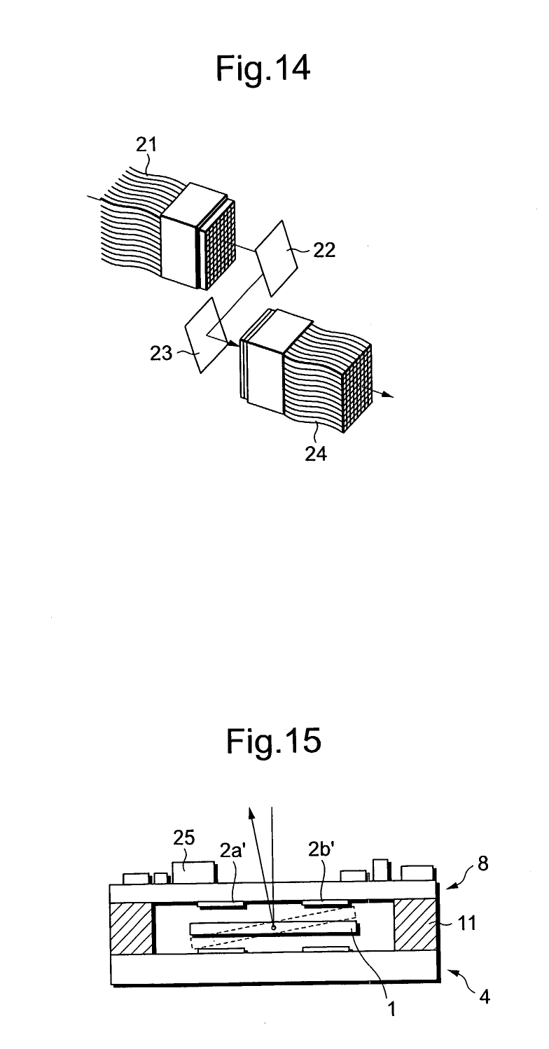

FIG. 14 shows the construction of the whole module when the optical device having the movable mirror of the present invention is used as an optical switch. Optical signals are made incident from a fiber array 21 to an optical switch. The incident optical signals are applied to a mirror array 22 which is arranged so as to face the fiber array 21. Here, the mirror array 22 has the structure in which a large number of mirrors described above are arranged in an array. The mirror, on the basis of the operation as described above, reflects the incident light in a predetermined direction. The reflected light is further made incident on the next mirror array 23 which also reflects the incident light in a predetermined direction to collect the reflected light to a fiber array 24. On the basis of this operation, the optical signal made incident on the fiber array 21 is sent to the target fiber array 24, thereby completing the switching operation.

Next, another embodiment of the present invention will hereinbelow be described. FIG. 15 shows an optical device of the present embodiment. In the present embodiment, the mirror is packed (sealed) in an enclosure. The enclosure, for example, is formed of the first substrate, the second substrate, and the other parts. An optical device of this sort prevents the mixing or the like of dust and moisture into the area in which a mirror is driven, and a disturbance due to the influence of the electromagnetic force from the outside. Such prevents situation that causes malfunction and failure and hence avoids a problem in many cases.

As shown in FIG. 15, a mirror 1 is hermetically or watertightly sealed with substrates 4 and 8, and a wall portion 11. The mirror 1 is perfectly shut out from the outside. This makes it possible to prevent mixing of dust and moisture from the outside. In addition, for example, by making the wall portion 11 of an electromagnetic shielding material, it is possible to prevent the disturbance due to the electromagnetic force from the outside. In the case, it also preferred that each of an upper-side electrode substrate 8 and upper-side electrode pads 2a′ and 2b′ is made of a optical signal-transmissible material. According to such as the structure, it can enhance the reliability of a module.

Furthermore, as another embodiment of the present invention, a matching material used to prevent the degradation of an optical signal can be injected into the sealed space shown in the above-mentioned the embodiment. For example, in the case where an optical signal is outputted from an optical fiber, the matching oil having refractive index common to the optical fiber is injected, thereby being able to realize the effect inherent therein.

As another embodiment of the present invention, as shown in FIG. 15, an upper-side electrode substrate 8 is loaded with a driving circuit component 25 such as an IC, thereby being able to realize the module of an optical device. This can have the merits such as space saving of a module, simplification of structure, reduction of manufacturing steps, and the like. Then, the optical device of the present invention may be used in an optical switch, a scanning system, a printer, or a display.

Note that, for the above-mentioned mirror driving device, the various driving means as well as the driving means utilizing the electrostatic force can be adopted. That is to say, the driving source for this mirror can be changed from the source utilizing the electrostatic force to the source utilizing another energy such as the electromagnetic force or the thermal deformation stress. For example, if the electromagnetic force is concerned, all of or a part of a mirror is made of a magnetic substance, and an electrically conductive coil is used instead of an upper-side electrode and a lower-side electrode, thereby being able to swing the mirror by the electromagnetic force. In any case, in the present invention, the driving force for a mirror is not intended to be limited to the electrostatic force, and the force energy can be applied as long as it acts so as to cancel the vertical force components.

What is claimed is:

1. An optical device by comprising:
a movable mirror between a movable mirror driving device and a substrate,
wherein said movable mirror driving device is made of an optical signal-transmissible material.

2. An optical device comprising:
a movable mirror between a first substrate and a second substrate; and
a first pair of movable mirror driving devices on said first substrate,
wherein said first pair of movable mirror driving devices is made of an optical signal-transmissible material.

3. An optical device according to claim 2, further comprising a second pair of movable mirror driving devices on said second substrate.

4. An optical device according to claim 3, wherein at least one of said first pair of a movable mirror driving device is arranged on an optical signal incident path to said movable mirror.

5. An optical device according to claim 4, wherein said first substrate is made of an optical-transmissible material.

6. An optical device according to claim 5, wherein said first pair of movable mirror driving devices is made of polysilicon.

7. An optical device according to claim 6, wherein said first substrate is a glass substrate.

8. An optical device according to claim 7, further comprising a capacitor between at least one of said first pair of a movable mirror driving devices and said movable mirror or at least one of said second pair of movable mirror driving devices and said movable mirror,
wherein said first pair of movable mirror driving devices and said second pair of movable mirror driving devices are electrodes.

9. An optical device according to claim 7, further comprising a capacitor between at least one of said first pair of movable mirror driving devices and said movable mirror and at least one of said second pair of movable mirror driving devices and said movable mirror,
wherein said first pair of movable mirror driving devices and said second pair of movable mirror driving devices are electrodes.

10. An optical device according to claim 7, wherein said first pair of movable mirror driving devices and said second pair of movable mirror driving devices are coils, and
a magnetic material is deposited onto at least one part of said mirror.

11. An optical device according to claim 2, wherein a driving circuit is formed on at least said first substrate or said second substrate.

12. A optical switch comprising at least one optical device according to claim 1.

13. A scanning system comprising at least one optical device according to claim 1.

14. A printer comprising at least one optical device according to claim 1.

15. A display comprising at least one optical device according to claim 1.

16. An optical device according to claim 5, wherein said movable mirror is packed in an enclosure, and
wherein said enclosure is formed of said first and second substrates and a portion for supporting said first and second substrates.

17. An optical device according to claim 16, wherein said enclosure is filled with gas or liquid other than air.

18. An optical device according to claim 16, wherein at least one part of said enclosure is made of an electromagnetic shielding material.

19. An optical device according to claim 16, wherein a driving circuit is formed on said enclosure.

20. A optical switch comprising at least one optical device according to claim 16.

21. A scanning system comprising at least one optical device according to claim 16.

22. A printer comprising at least one optical device according to claim 16.

23. A display comprising at least one optical device according to claim 16.

24. A method of driving a movable mirror comprising:
applying a voltage to an electrode; and
generating an electrostatic force between said electrode and said movable mirror to drive said movable mirror in response to said electrostatic force and causing an optical signal to be transmitted through said electrode.

25. A method of driving a movable mirror comprising:
applying a voltage to a coil; and
generating an electromagnetic force between said coil and said movable mirror to drive said movable mirror in response to said electromagnetic force and causing an optical signal to be transmitted through said coil.
